(19) United States
(12) Patent Application Publication
(10) Pub. No.: US 2026/0237109 A1
(43) Pub. Date: Aug. 13, 2026

(54) IMAGE GENERATION BASED ON TEXT

(71) Applicant: Beijing Zitiao Network Technology Co., Ltd., Beijing (CN)

(72) Inventors: Xin Xia, Beijing (CN); Huiyang Shao, Beijing (CN); Xuefeng Xiao, Beijing (CN)

(21) Appl. No.: 19/534,119

(22) Filed: Feb. 9, 2026

(30) Foreign Application Priority Data
Feb. 8, 2025 (CN) 202510140531.9

(51) Int. Cl. G06T 11/00; G06N 3/0455; G06N 3/08

(52) U.S. Cl. CPC G06T 11/00; G06N 3/0455; G06N 3/08

(57) ABSTRACT

A method, an apparatus, a device, and a medium for generating an image based on a text are provided. In the method, in response to receiving a text for generating an image, a text feature corresponding to the text is determined in a text feature space of the text with a text feature model. A latent feature corresponding to the text feature is determined, with a text encoder, in a latent space different from the text feature space. The latent space is configured to aligning the text feature space and an image feature space of the image. The image corresponding to the text is determined, with a diffusion model, based on the latent feature.

### CROSS-REFERENCE

This application claims the priority of Chinese Patent Application No. 202510140531.9, filed on Feb. 8, 2025, entitled “METHOD, APPARATUS, DEVICE, AND MEDIUM FOR GENERATING IMAGE BASED ON TEXT”, the entire content of which is incorporated herein by reference.

### FIELD

Implementations of the present disclosure generally relate to image generation, and in particular, to image generation based on a text.

### BACKGROUND

Machine learning techniques have been widely used in the field of image generation. In particular, a diffusion model has become a primary model for text-based image generation. The diffusion model may generate high-quality and creative images while supporting a relatively high resolution, and thus has been widely used in image generation tasks. However, the performance of the diffusion model is not satisfactory in some cases, and the problem of poor quality of generated images may exist. In this case, it is desired to further improve the quality of the generated images.

### SUMMARY

In a first aspect of the present disclosure, there is provided a method of generating an image based on a text. In the method, in response to receiving a text for generating an image, a text feature corresponding to the text is determined in a text feature space of the text with a text feature model. A latent feature corresponding to the text feature is determined, with a text encoder, in a latent space different from the text feature space. The latent space is configured to aligning the text feature space and an image feature space of the image. The image corresponding to the text is determined, with a diffusion model, based on the latent feature.

In a second aspect of the present disclosure, there is provided an apparatus for generating an image based on a text. The apparatus includes: a first feature determination module configured to determine, with a text feature model and in response to receiving a text for generating an image, a text feature corresponding to the text in a text feature space of the text; a second feature determination module configured to determine, with a text encoder, a latent feature corresponding to the text feature in a latent space different from the text feature space, the latent space being configured to align the text feature space and an image feature space of an image; and an image determination module configured to determine, with a diffusion model, the image corresponding to the text based on the latent feature.

In a third aspect of the present disclosure, there is provided an electronic device. The electronic device includes: at least one processor; and at least one memory. The at least one memory is coupled to the at least one processor and storing instructions executable by the at least one processor. The instructions, when executed by the at least one processor, causing the electronic device to perform the method of the first aspect.

In a fourth aspect of the present disclosure, there is provided a computer-readable storage medium having stored thereon a computer program that, when executed by a processor, causes the processor to implement the method of the first aspect.

In a fifth aspect of the present disclosure, there is provided a computer program product including a computer program, where the computer program, when executed by a processor, implements the method of the first aspect.

It would be appreciated that the content described in the Summary section is neither intended to define key or essential features of implementations of the present disclosure, nor is it intended to be used to limit the scope of the present disclosure. Other features of the present disclosure will be readily envisaged through the following description.

### BRIEF DESCRIPTION OF DRAWINGS

The above and other features, advantages, and aspects of implementations of the present disclosure will become more apparent in the following, in conjunction with the drawings and with reference to the following detailed description. In the drawings, the same or similar reference symbols refer to the same or similar elements, where:

FIG. 1 illustrates a block diagram of different types of prior distributions involved in a diffusion model in accordance with an implementation of the present disclosure;

FIG. 2 illustrates a block diagram for generating an image based on a text in accordance with some implementations of the present disclosure;

FIG. 3 illustrates a block diagram of a processing architecture in accordance with some implementations of the present disclosure;

FIG. 4 illustrates a block diagram of a structure of a text encoder in accordance with some implementations of the present disclosure;

FIG. 5 illustrates a block diagram for determining a loss of the text encoder in accordance with some implementations of the present disclosure;

FIG. 6 illustrates a block diagram for determining a loss of the text encoder in accordance with some implementations of the present disclosure;

FIG. 7 illustrates a flowchart of a method for generating an image based on a text in accordance with some implementations of the present disclosure;

FIG. 8 illustrates a block diagram of an apparatus for generating an image based on a text in accordance with some implementations of the present disclosure; and

FIG. 9 illustrates a block diagram of a device capable of implementing a plurality of implementations of the present disclosure.

### DETAILED DESCRIPTION OF EMBODIMENTS

The implementations of the present disclosure are described in more detail below with reference to the drawings. Although some implementations of the present disclosure are shown in the drawings, it would be appreciated that the present disclosure may be implemented in various forms and should not be construed as limited to the implementations set forth herein; rather, these implementations are provided for a more thorough and complete understanding of the present disclosure. It would be appreciated that the drawings and implementations of the present disclosure are only for illustrative purposes and are not intended to limit the scope of protection of the present disclosure.

In the description of the implementations of the present disclosure, the term “include/comprise” and similar terms thereof are to be construed as open-ended inclusions, that is, “include/comprise but not limited to”. The term “based on” is to be construed as “at least partially based on”. The term “one implementation” or “the implementation” is to be construed as “at least one implementation”. The term “some implementations” is to be construed as “at least some implementations”. The following may also include other explicit and implicit definitions. As used herein, the term “model” may represent an association relationship between various data. For example, the above association relationship may be obtained based on various technical solutions currently known and/or to be developed in the future.

It would be appreciated that the data involved in the technical solution (including but not limited to the data itself, acquisition or use of the data) should comply with requirements of corresponding laws, regulations, and related provisions.

It would be appreciated that before the use of the technical solution disclosed of the embodiments of the present disclosure, the user shall be informed of the type, range of use, use scenarios, etc. of personal information involved in the present disclosure through appropriate manners and the authorization of the user shall be obtained in accordance with relevant laws and regulations.

For example, in response to receiving an active request from a user, prompt information is sent to the user to clearly inform the user that the requested operation will require access to and use of personal information of the user. In this way, the user may independently choose, based on the prompt information, whether to provide personal information to software or hardware, such as an electronic device, an application, a server, or a storage medium, that performs the operations of the technical solution of the present disclosure.

As an optional but non-limiting implementation, in response to receiving the active request from the user, the prompt information may be sent to the user in the form of, for example, a pop-up window, in which the prompt information may be presented in text. In addition, the pop-up window may also include a selection control for the user to select whether to “agree” or “disagree” to provide the personal information to the electronic device.

It would be appreciated that the above process of notifying and obtaining user authorization is only illustrative and does not constitute a limitation on the implementations of the present disclosure, and other methods that satisfy relevant laws and regulations may also be applied in the implementations of the present disclosure.

The term “in response to” used herein represents a state in which a corresponding event occurs or a condition is satisfied. It would be appreciated that the timing of performing a subsequent action performed in response to the event or condition is not necessarily strongly correlated with the time at which the event occurs or the condition is satisfied. For example, in some cases, the subsequent action may be performed immediately when the event occurs or the condition is satisfied; in other cases, the subsequent action may be performed after a period of time after the event occurs or the condition is satisfied.

### Example Environment

The diffusion model may generate high-quality and creative images while supporting a relatively high resolution, and thus has been widely used in image generation tasks. In summary, the diffusion model is a deep learning model based on a probabilistic generative model that generates data by simulating a physical diffusion process. The core idea of the diffusion model is to gradually transform data into noise through a forward diffusion process and then gradually recover the original data from the noise through a reverse generation process. In the reverse process, a noise image (for example, random noise) may be input to the diffusion model and content of the image may be specified with an input text, and the diffusion model may recover, from the noise image, an image including the content specified by the text.

The diffusion model has become a primary method commonly used in generative modeling. Despite the good performance of the diffusion model, since different types of image priors are mixed into a single standard Gaussian distribution, this may lead to instability in the generation process of the diffusion model. It would be appreciated that the text may specify different types of images, for example, the text “cat” may specify that an image including a cat is to be generated, and the text “dog” may specify that an image including a dog is to be generated. However, the existing diffusion model determines the initial noise image based on a single standard Gaussian distribution, which may result in all types of prior knowledge being mixed into a single standard Gaussian distribution. In this case, overlapping or even confusing paths may be caused in the sampling process for different types of data.

Despite the significant advantages of the diffusion model, the diffusion model still has some deficiencies, which may hinder the actual deployment and scalability of the diffusion model. Attributed to a homogeneous prior distribution, the diffusion model has instability. The existing diffusion model uses a standard Gaussian distribution as a prior and merges different image priors into a single uniform distribution. As the model struggles to distinguish different image semantics within a unified latent space, this mixing may lead to instability in the generation process. Regarding the sampling path overlap and the fuzzy score direction, when a plurality of image priors share a same standard Gaussian prior, their sampling paths may significantly overlap. Because the average of different score functions may blur the true gradient required for realizing effective denoising, such path overlap may make it difficult to correctly recognize the score direction, resulting in degraded model quality.

The existing diffusion model lacks a differentiated prior representation, which reduces the divergence and quality and may lead to a smaller divergence between the generated data distribution and the real data distribution. Without using different priors to guide the generation process, the image generated by the model has relatively low fidelity and poor semantic alignment with the input text. In this case, it is desired to adjust the technical solution of the diffusion model, and it is desired to generate, in a more accurate manner, the image including the content specified by the text.

### Overview of Image Generation

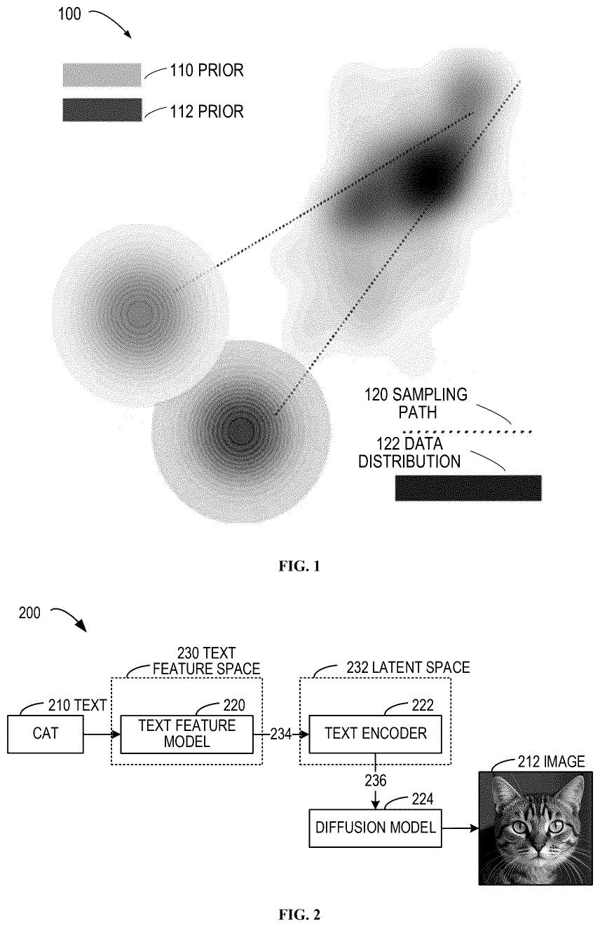

To avoid the above problem, the present disclosure proposes a prior distribution with different types divided. The prior distributions are described with reference to FIG. 1, which illustrates a block diagram 100 of different types of prior distributions involved in a diffusion model in accordance with an implementation of the present disclosure. Assuming that only two types of images are considered: cats and dogs. Amore reasonable prior distribution should separate the priors of cats and dogs independently. Then, noise images may be sampled from their respective distribution ranges and then a denoising process may be performed to generate data distributions of clear images including cats and dogs, respectively.

As shown in FIG. 1, a legend 110 represents a prior of an image including a “cat”, and a legend 112 represents a prior of an image including a “dog”. In this case, the distributions of different priors in the entire data space are different. A legend 120 represents a sampling path, that is, a path to gradually recover a clear image from a noise image, and a legend 122 represents the data distribution of the recovered clear image. It can be seen from FIG. 1 that different texts correspond to different types of images, and the priors of the cat and the dog may be predefined as two different standard Gaussian distributions, respectively. Then, when generating an image of a cat or a dog, an initial noise image may be sampled and obtained from a corresponding prior distribution, respectively, and then the initial noise image may be denoised to obtain a clear image. In this way, path overlap and confusion may be minimized, thereby improving the quality of the generation result.

In the context of the present disclosure, a latent space may be provided in which different texts correspond to different latent features. Therefore, a latent feature including relevant knowledge of the text may be used as the input of a diffusion model, thereby improving the quality of an image generated by the diffusion model. Specifically, in the process of generating different images including “cat” and “dog”, an initial noise image for generating “cat” is different from an initial noise image for generating “dog”. In this way, the path overlap and confusion for generating different images may be reduced, thereby improving the quality of the generation result.

More details of image generation are described with reference to FIG. 2, which illustrates a block diagram 200 of generating an image based on a text in accordance with some implementations of the present disclosure. As shown in FIG. 2, a text for generating an image may be received. For example, a text 210 may specify to generate an image including a “cat”. In response to receiving the text 210 for generating an image, a text feature 234 corresponding to the text 210 may be determined in a text feature space 230 of the text 210 with a text feature model 220. Here, the text feature model 220 may be trained with an existing technical solution and have fixed parameters. The text feature model 220 may have different architectures, and based on the architecture of the text feature model 220, the text feature space 230 may have different dimensionalities (for example, 1*n, or 1*n*n, etc.).

Further, a latent feature 236 corresponding to the text feature 234 may be determined in a latent space 232 different from the text feature space 230 with a text encoder 222. Here, the latent space 232 is configured to align a text feature space and an image feature space of an image. For example, the dimensionality of the latent space 232 may be equal to the dimensionality of an image feature space (for example, 1×4×w×h, where 4 represents the number of rgba channels of the image, w represents the image width, and h represents the image height). Alternatively and/or in additionally, the dimensionality of the latent space 232 may be lower than the dimensionality of an image feature space (for example, the values of w and h may be lower than the width and height of the image, respectively, etc.). In this case, the latent feature 236 may include more knowledge about the content of the image. As compared to using a single standard Gaussian distribution as the starting point of the denoising process of the diffusion model, a latent feature may determine the path of the denoising process in a more accurate manner, thereby generating a clear and more accurate image. Further, an image 212 corresponding to the text 210 may be determined using a diffusion model 224 based on the latent feature 236.

With some implementations of the present disclosure, a text-related feature may be utilized as a different prior in a unified latent space to achieve scalable and efficient text-conditioned image generation. The text encoder may be implemented, for example, using a text variational autoencoder (VAE) architecture, and the text VAE may effectively align the text representation with the visual feature, thereby ensuring semantic consistency and improving the quality of the generated image. Further, an OU (Ornstein-Uhlenbeck) diffusion bridge may be adopted to reduce the overhead of iterative denoising while maintaining stability, thereby facilitating faster and more stable image generation. As compared to existing diffusion technologies, the proposed framework not only accelerates the generation process, but also achieves efficient alignment between the text input and the visual output. In this way, a more efficient and scalable generation model may be provided, and in particular, the performance of applications that require high-fidelity text-to-image synthesis may be improved.

According to some implementations of the present disclosure, the diffusion model progressively generate, based on a stochastic differential equation (SDE), data by iteratively denoising latent variables. This iterative denoising process not only supports generative performance, but also provides flexibility for various optimizations.

On the one hand, the present disclosure proposes a text VAE for differentiated prior representation. The text VAE may align text embeddings with latent image representations in a unified latent space. By treating different text embeddings as different priors, the model may ensure that different semantic types are well separated. This separation may alleviate the instability caused by mixing different image priors and enhance the ability of the model to generate semantically consistent images.

On the other hand, the present disclosure proposes an OU diffusion bridge that supports stable sampling. The utilization of an OU process may further improve the stability, and a diffusion bridge which is effective and stable denoise can be achieved. The diffusion bridge reduces the overlap of sampling paths by providing different trajectories for different priors, thereby improving the accuracy of score direction estimation and enhancing the quality of generated images.

Further, the divergence and generation quality may be improved through the prior representation. By explicitly representing the prior in the latent space, the divergence between a distribution of generated data and a distribution of real data may be improved. In this way, the generation process may be guided more effectively, thereby achieving higher fidelity images better aligned with their text descriptions. The proposed technical solution not only enables a stable generation process, but also significantly enhances the alignment between a text input and a visual output. Experiments demonstrate that as compared to existing diffusion technologies, the proposed technical solution may accelerate the generation process while achieving superior generation quality. In this way, a more efficient and scalable generation model may be achieved, especially in text-image translation applications.

### Detailed Process of Image Generation

For ease of description, the meanings of the symbols used in the present disclosure is first introduced. In a diffusion process, x∈ [symbol] follows a data distribution q_{data}(x). A diffusion model is defined by a sequence of random variables indexed by time

$${\{ {x}_{t} \}}_{t = 0}^{T} ,$$

where x₀~p₀(x):=q_{data}(x) and x_{T}~p_{T}(x):=pₚᵣᵢₒᵣ(x). This process may be solved under a stochastic differential equation.

$${dx}_{t} = f ( {x}_{t} , t ) dt + g ( t ) {dw}_{t} \qquad Formula ( 1 )$$

In the above formula, f: [symbol] ×[0,T]→ [symbol] represents a drift function, g:[0,T]→ [symbol] represents a diffusion coefficient, and wₜ represents a Wiener process. By performing backward diffusion, the distribution may be solved according to the following.

$${dx}_{t} = [ f ( {x}_{t} , t ) - {g ( t )}^{2} {∇}_{{x}_{t}} log p ( {x}_{t} ) ] dt + g ( t ) {dw}_{t} \qquad Formula ( 2 )$$

In the above formula, p(xₜ) represents a marginal distribution of xₜ. A equivalent deterministic formula (called the probability flow ODE) is expressed as:

$${dx}_{t} = [ f ( {x}_{t} , t ) - \frac{1}{2} {g ( t )}^{2} {∇}_{{x}_{t}} log p ( {x}_{t} ) ] dt \qquad Formula ( 3 )$$

In the above formula, both the reverse SDE and the probability flow ODE share a same set of margins as a original forward SDE.

Regarding score matching, a key component of a reverse process is a score function ∇ₓ_{ₜ} log p(xₜ). In practice, atypical process is to train a neural network s_{θ}(xₜ,t) to approximate a true score via score matching:

$$ℒ ( θ ) = {𝔼}_{{x}_{t} , {x}_{0} , t} [ {‖ {s}_{θ} ( {x}_{t} , t ) - {∇}_{{x}_{t}} log p ( {x}_{t} \vert {x}_{0} ) ‖}^{2} ] \qquad Formula ( 4 )$$

The above objective may be minimized and

$${s}_{θ}^{*} ( {x}_{t} , t )$$

that may accurately approximate the true score may be determined. The training process may be based on a Gaussian transition kernel and the following may be specified when defining the diffusion process:

$${x}_{t} = {α}_{t} {x}_{0} + {σ}_{t} ϵ , ϵ ∼ 𝒩 ( 0 , I ) \qquad Formula ( 5 )$$

In the above formula, αₜ and σₜ may represent time-dependent parameters.

The present disclosure proposes a bridge model. Many diffusion-based methods focus on mapping a complex real-world distribution to a simple Gaussian distribution. However, for a transformation task between two general distributions (for example, image-to-image), it may be more flexible to specify the desired end-state of a diffusion process. Doob's h-transform may adjust the diffusion to end at a selected point y.

Regarding a stochastic bridge via the h-transform, for the SDE in formula (1), the h-transform may be applied to generate a bridge SDE:

$${dx}_{t} = f ( {x}_{t} , t ) dt + {g ( t )}^{2} h ( {x}_{t} , t , y , T ) + g ( t ) {dw}_{t}$$

In the above formula, x₀~q_{data}(x) and x_{T}=y. The function h is defined as follows:

$${∇}_{{x}_{t}} log p ( {x}_{T} \vert {x}_{t} ) {\vert}_{{x}_{t} = x , {x}_{T} = y} ,$$

In the above formula, the gradient of a log-transition kernel describes xₜ→x_{T}= [symbol] . With appropriate choices of drift and diffusion (f(xₜ,t)=0), for example, the kernel remains a mild gradient since it is Gaussian.

Regarding a denoising diffusion bridge model, a joint distribution (y, [symbol] )~q_{data}(x, [symbol] ) on the pair in the R^{d} space may be considered. By a properly designed reverse bridge process, q_{data}(x|±) may be learned using the diffusion bridge. Given a process

$${\{ {x}_{t} \}}_{t = 0}^{T}$$

with a margin q(xₜ) such that q(x₀, x_{T})≈q_{data}(x₀, x_{T}), the reverse process aims to sample from the following space: x_{T}|x_{T}= [symbol] . For t≤T−ϵ (for example, for some ϵ>0), a distribution q(xₜ|x_{T}) follows a reverse SDE.

$${dx}_{t} = [ f ( {x}_{t} , t ) - {g}^{2} ( t ) ( s ( {x}_{t} , t , y , T ) - h ( {x}_{t} , t , y , T ) ) ] dt + g ( t ) d {\tilde{w}}_{t} ,$$

In the above formula, \tilde{w}ₜ is a Wiener process, and s(xₜ, t, y, T)=∇ₓ_{ₜ} log q(xₜ|x_{T})_{x,y}. The associated probability flow ODE is expressed as:

$${dx}_{t} = [ f ( {x}_{t} , t ) - {g}^{2} ( t ) ( \frac{1}{2} s ( {x}_{t} , t , y , T ) - h ( {x}_{t} , t , y , T ) ) ] dt$$

Table 1 shows a bridge where a variance preserving (VP) and a variance exploding (VE) processes appear as a special case.

TABLE 1
VP and VE instantiations of a diffusion bridge

| | f(xₜ, t) | g²(t) | p(xₜ\|x₀) |
|---|---|---|---|
| VP | $\frac{d log {α}_{t}}{dt} {x}_{t}$ | $\frac{d}{dt} {σ}_{t}^{2} - 2 \frac{d log {α}_{t}}{dt} {σ}_{t}^{2}$ | $𝒩 ( {α}_{t} {x}_{0} , {σ}_{t}^{2} I )$ |
| VE | 0 | $\frac{d}{dt} {σ}_{t}^{2}$ | $𝒩 ( {x}_{0} , {σ}_{t}^{2} I )$ |

Regarding the OU process, an OU bridge (OUB) is proposed. The OU process may be shown as follows:

$${dx}_{t} = θ ( μ - {x}_{t} ) dt + {dw}_{t} \qquad Formula ( 6 )$$

Applying Doob's h-transform may result in an OU bridge that preserves the uniform reversibility of the OU process and ensures xₜ=μ at the same time.

Regarding the generalized OU (abbreviated as GOU), the generalized OU process allows time-dependent coefficients:

$${dx}_{t} = {θ}_{t} ( μ - {x}_{t} ) dt + {g}_{t} {dw}_{t} \qquad Formula ( 7 )$$

to subject to the constraint

$$2 {λ}^{2} = \frac{{g}_{t}^{2}}{{θ}_{t}} ,$$

where λ is a constant that controls the variance. There are a plurality of processes, including VP and VE. Note that when θₜ=θ, and gₜ=1 (with appropriate constants), the GOU process may be transformed into a standard OU process. For the VE process, consider letting θₜ→0 and keeping gₜ controlled by λ². A pure explosion process may be recovered in which the variance grows with time and is consistent with VE. On the other hand, letting μ→0 and λ→1 may mimic the mechanism of the VP process.

The mathematical formulas on which the present disclosure is based have been described, and the specific process of image generation will be described below. According to some implementations of the present disclosure, in the process of determining, with a diffusion model based on a latent feature, an image corresponding to a text, the latent feature may be inputted to the diffusion model as an initial noise feature, and then the diffusion model may be utilized to perform denoising processing for the initial noise feature to determine the image. With some implementations of the present disclosure, the initial noise feature may include more knowledge about the input text. In this way, the respective initial noise features may be customized for different types of input texts, so that the denoised images match the input texts more.

According to some implementations of the present disclosure, a new model architecture “text VAE” and a diffusion training framework called ITOUB (Image Text Ornstein-Uhlenbeck Bridge) are proposed. This framework may integrate a text variational autoencoder with a diffusion bridge to achieve stable and efficient text-image generation. The core idea of the present disclosure is to treat text embeddings as target images in a diffusion framework, thereby establishing a clear correspondence between text concepts and visual representations.

However, in the process of defining different types of prior distributions, two key requirements need to be satisfied: (1) the number of image types is too large to manually define a prior of each image type, so it is necessary to select feature representations and align them using a weak supervision method; (2) the divergences between different types of priors in the feature space should correspond to actual physical meanings in reality.

It would be appreciated that an input text for generating a image may naturally satisfy these requirements. The input text may be transformed into a latent space to generate a prior distribution, and different texts represent the combinations of different types of priors. In addition, the divergences between these distributions may be aligned with the pre-trained text embedding model to ensure consistency with the actual physical meanings in reality.

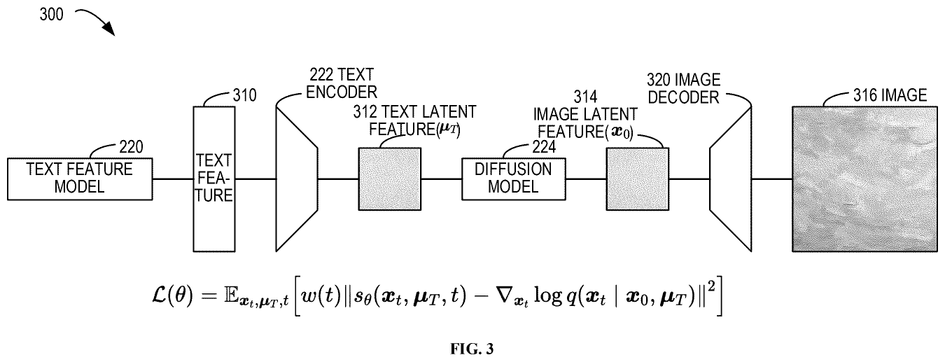

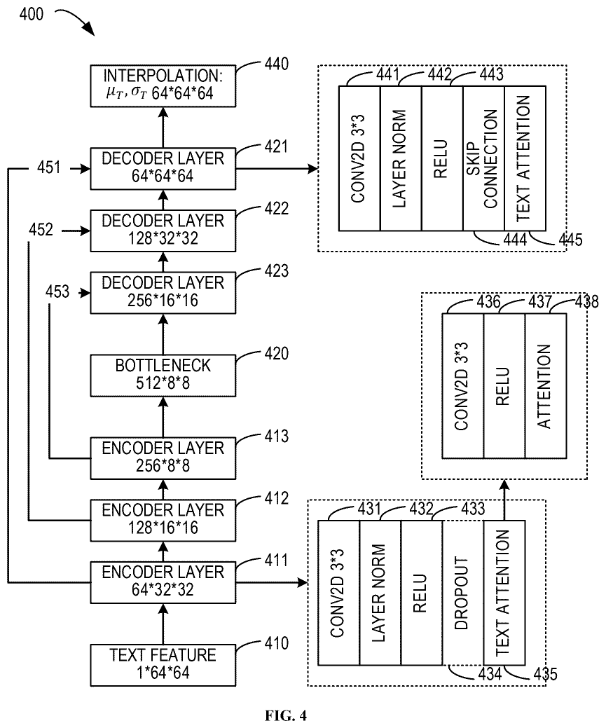

More details of the architecture for generating the image are described with reference to FIG. 3, which illustrates a block diagram 300 of a processing architecture in accordance with some implementations of the present disclosure. The input text uses a pre-trained text feature model 220 to extract a text feature (e.g., embeddings), a latent feature are then generate by a text encoder. An image decoder then reconstructs or generates an image code from the latent feature. As shown in FIG. 3, starting from the left side of FIG. 3, the input text (for example, the text “cat” or “dog” specifying image content, etc.) may be processed with the text feature model 220 to obtain a corresponding text feature 310. A text encoder 222 may be constructed for transforming the text feature 310 into a text latent feature 312 in the latent space.

The text encoder 222 may align a text feature and a image feature in a unified latent space. According to some implementations of the present disclosure, the dimensionality of the latent space is higher than the dimensionality of the text feature space, and the dimensionality of the latent space is determined based on the dimensionality of an image feature space of an image. With some implementations of the present disclosure, more knowledge about the text may be introduced into the latent space to align with the image feature space with a higher dimensionality.

According to some implementations of the present disclosure, the text feature is treated as a compact, grayscale-like representation (e.g., with dimensionality 1×n²→1×n×n) which is then mapped to “color” space with a higher dimensionality (e.g., 1×4×w×h, where 4 represents the number of rgba channels of the image, w represents the image width, and h represents the image height). A pre-trained and frozen text feature model may be used to transform the original text into feature with a fixed dimensionality. This feature is then processed by the text encoder, yielding a latent feature z text including semantic information.

Further, an initial noise feature (that is, a noise image feature μ_{T} at time T, which may also be expressed as x_{T}) to be inputted to a diffusion model 224 may be determined based on the text latent feature 312. The diffusion model 224 may be utilized to perform the denoising process to obtain a image latent feature 314 (x₀) corresponding to a clear image. Then, an image decoder 320 may be utilized to decode the image latent feature 314 to obtain a clear image 316. It would be appreciated that the above process represents a process of using the pre-trained text encoder 222 to generate the text latent feature 312. The text encoder 222 may be trained with reference samples.

The reference sample may include a reference image (for example, an image of a cat) and a reference text (for example, the title of the image “cat”). In the training process, the reference image may be transformed into an image latent embedding x using a pre-trained image encoder, and the reference text may be transformed into a text feature (for example, a vector) using a pre-trained text feature model. Then, the text VAE may be trained to map the text features into the latent space as a text latent feature xₜ. Therefore, the start point and the end point of the diffusion model may be determined, and the diffusion model may be trained using the OU process of the diffusion bridge model.

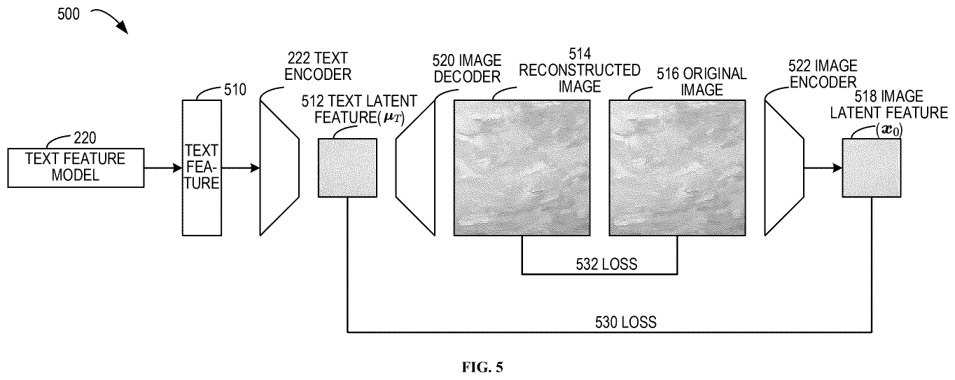

According to some implementations of the present disclosure, the text encoder may be implemented based on various manners. FIG. 4 illustrates a block diagram 400 of a structure of a text encoder in accordance with some implementations of the present disclosure. FIG. 4 illustrates the architecture of a text VAE for implementing the text encoder. This network combines a U-Net based integrated local codec framework and a global attention mechanism, layer normalization, and dynamic image resolution adjustment, similar to image colorization and super-resolution tasks.

Regarding the architectural details of the text encoder, a text VAE is proposed. The text VAE may employ a stochastic natural network designed for tasks such as image colorization and super-resolution processing. A U-Net-like encoder-decoder structure may be combined with an advanced attention mechanism. One or more encoder layers compress input data into hierarchical feature representations by reducing the spatial dimensions, while one or more decoder layers reconstruct them to the desired resolution using transposed convolutions. Skip connections between the encoder and decoder may ensure that spatial details are preserved, improving image fidelity and accelerating convergence. This architecture uses layer normalization for training stability, ReLU activation is for efficient gradient flow, and a final Tanh activation to keep output pixel values within an appropriate range.

As shown in FIG. 4, the text VAE may include a plurality of encoder layers 411, 412, 413, a bottleneck 420, and a plurality of decoder layers 423, 422, and 421, and an interpolation layer 440 (optional). The text VAE may receive a text feature 410 and output a corresponding latent feature. Specifically, the dimensionality of the text feature 410 may be expressed as 1*64*64, and the encoder layers 411, 412, and 413 may gradually adjust the dimensionality of the feature. Specifically, taking the encoder layer 411 as an example, the encoder layer may include a convolutional layer 431, a normalization layer 432, a ReLU layer 433, a dropout layer 434 (optional), and a text attention layer 435. Further, the text attention layer may include a convolutional layer 436, a ReLU layer 437, and an attention layer 438.

Further, the text VAE may include a plurality of decoder layers 423, 422, and 421. Taking the decoder layer 421 as an example, the decoder layer may include a convolutional layer 441, a normalization layer 442, a ReLU layer 443, a skip connection 444, and a text attention layer 435. There may be skip connections between the encoder layers and the decoder layers, for example, a skip connection 451 between the encoder layer 411 and the decoder layer 421, a skip connection 452 between the encoder layer 412 and the decoder layer 422, and a skip connection 453 between the encoder layer 413 and the decoder layer 423. In this case, the skip connections may fuse the features in the encoder and the decoder, thereby retaining more detailed information and making the generated image more realistic.

According to some implementations of the present disclosure, a LocalAttention module and a GlobalAttention module may be integrated in a TextAttention block. The LocalAttention module (Conv2d, ReLU) may refines fine-grained details in local regions, which is crucial for tasks like precise color assignment. The GlobalAttention (a traditional attention module) uses self-attention to capture long-range dependencies and contextual relationships across the image. These modules work in concert to balance local detail refinement with global context understanding, resulting in coherent and visually appealing output.

According to some implementations of the present disclosure, the text encoder includes an interpolation layer set based on a difference between a dimensionality of the image feature space and a dimensionality of the latent space. With some implementations of the present disclosure, generating images with different resolutions in a more accurate manner can be supported. Specifically, interpolation (e.g., f interpolate) may be utilized to dynamically adjust the size of an output image, thereby enabling the model to handle varying output resolutions without modifying the architecture, making it highly adaptive and versatile. In the process of configuring the text encoder, the resolution of an expected generated image may be obtained, and the interpolation may be set based on the resolution. In this way, the position of a prior in the latent space may be adjusted by adjusting μ_{T} and σ_{T}, so that the generated image matches the expected resolution more.

According to some implementations of the present disclosure, in the process of training a text encoder, a reference sample may be obtained, and the reference sample includes a reference text and a reference image. A loss function for updating the text encoder may be determined via the latent space based on the reference text and the reference image, and the text encoder may be updated based on the loss function. With some implementations of the present disclosure, the loss function may include information in a plurality of aspects, thereby improving the accuracy of determining prior distributions of different types of texts.

For the training of the text VAE, a multi-angle training and alignment approach may be adopted to ensure that it may be seamlessly integrated into existing workflows without compromising the performance of the original image VAE. Therefore, training of an objective function must ensure that the generated text latent embeddings are aligned as closely as possible with the image latent embeddings to allow the diffusion model to denoise and recover the original image. At the same time, the training process must maintain the alignment between different types of representation vectors in a latent space and an original text embedding model.

More details about training a text encoder are described with reference to FIG. 5, which illustrates a block diagram 500 for determining a loss of the text encoder in accordance with some implementations of the present disclosure. In summary, an input text uses the pre-trained text feature model 220 to extract a text feature 510. a text latent feature 512 is then generated by the text encoder 222. An image decoder 520 then generates a reconstructed image 514 from the text latent feature 512. Further, A loss for training a text encoder may be determined from the aspects of the image and the features, respectively, to ensure that the reconstructed image matches the original image as closely as possible and to minimize the distance between the text latent feature and the image latent feature.

According to some implementations of the present disclosure, in the process of determining the loss function for updating the text encoder via the latent space, a reference text feature corresponding to a reference text may be determined in the latent space with a text encoder. A reference image feature corresponding to a reference image may be determined in the latent space with an image encoder. A loss function may be determined based on a difference between the reference text feature and the reference image feature. With some implementations of the present disclosure, the difference between the latent feature in the latent space and the image feature may be reduced, thereby enabling the latent space to improve the alignment level between the text feature space and the image feature space.

As shown in FIG. 5, the reference text may be input to the text feature model 222, and a reference text feature (for example, the text latent feature 512) corresponding to the reference text may be determined in a latent space with the text encoder 222. Further, a reference image feature (for example, an image latent feature 518) corresponding to the reference image (for example, an original image 516) may be determined in the latent space with the image encoder 522. A loss 530 may be determined based on a difference between the reference text feature and the reference image feature.

According to some implementations of the present disclosure, in the process of determining the loss function for updating the text encoder via the latent space, a reference text feature corresponding to a reference text may be determined in a latent space with a text encoder. A reference reconstructed image corresponding to a reference text feature may be determined with an image decoder. Further, A loss function may be determined based on a difference between the reference reconstructed image and the reference image. With some implementations of the present disclosure, the reconstructed image generated based on the latent feature may match the original image more, thereby enabling the latent space to improve the alignment level between the text feature space and the image feature space.

As shown in FIG. 5, a reference text may be input to the text feature model 220, and a reference text feature (for example, the text latent feature 512) corresponding to the reference text may be determined in the latent space with the text encoder 222. A reference reconstructed image (for example, the reconstructed image 514) corresponding to the reference text feature may be determined with the image decoder 520. Further, a loss 532 may be determined based on a difference between the reference reconstructed image and the reference image (for example, the original image 516).

According to some implementations of the present disclosure, the reference sample may include a plurality of reference samples. For example, the reference sample includes a first reference sample and a second reference sample, and a first type of a first reference text in the first reference sample is different from a second type of a second reference text in the second reference sample. Different types of reference samples may be utilized to train the text encoder in an iterative manner until the text encoder can accurately distinguish different types of priors.

According to some implementations of the present disclosure, in the process of determining the loss function for updating the text encoder via the latent space, the prior distributions of a plurality of prior texts respectively corresponding to the first type and the second type in the latent space may be obtained. The first reference text feature corresponding to the first reference text and the second reference text feature corresponding to the second reference text may be determined in the latent space with the text encoder. A distribution of the first reference text feature and the second reference text feature in the latent space may be determined. Further, the loss function may be determined based on a difference between the prior distributions and the distribution. With some implementations of the present disclosure, a distribution of the output of a text encoder can be consistent with a distribution an original physical meaning of a text, thereby improving the performance of the text encoder.

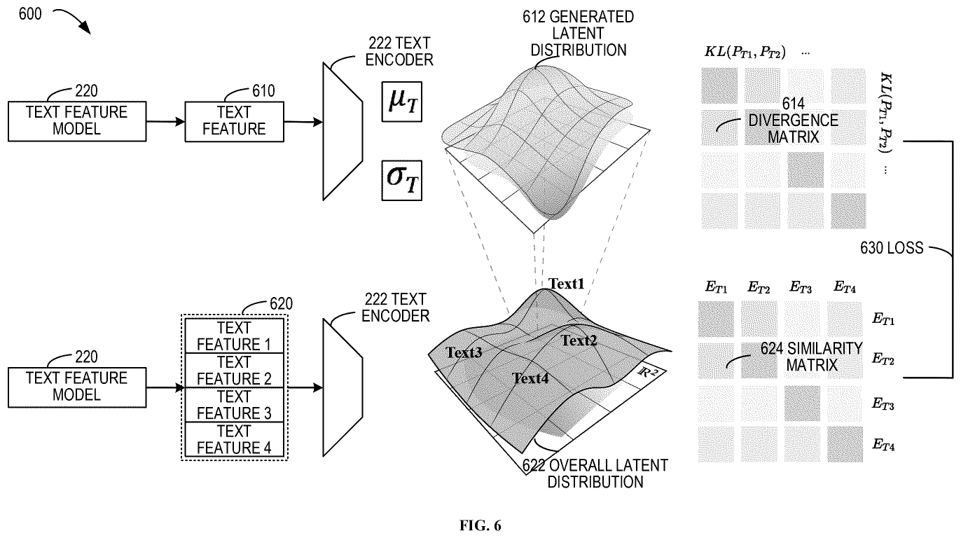

More details are described with reference to FIG. 6, which illustrates a block diagram 600 for determining a loss of the text encoder in accordance with some implementations of the present disclosure. FIG. 6 shows a diagram of latent space alignment and distribution analysis. a text feature 610 on the left is encoded into a generated latent distribution 612. Similar text inputs will produce similar latent distributions (for example, represented by the divergence matrix on the right), and the degree of preservation of semantic proximity is evaluated. As shown in FIG. 6, the divergence constraint may be applied to the text VAE to ensure that different types of representation vectors are aligned with the original text embedding model. This allows a feature space where different types of prior distributions have well representations. Specifically, a method similar to the CLIP method may be followed, and the KL divergence between the generated prior distributions under different text inputs may be evaluated and aligned with the similarity matrix of text embeddings.

Specifically, the text feature 610 may be determined with the text feature model 220. In this case, for different types of texts, the text encoder 222 may determine corresponding priors (for example, represented with μ_{T} and σ_{T}). Assuming that there are four types of texts, a corresponding text feature 620 (including text features 1 to 4) may be determined with the text feature model 220. Then, a text encoder may be utilized to determine a position of each text in an overall latent distribution 622, and a similarity matrix 624 may be determined based on the respective positions. Further, a divergence matrix 614 may be compared with a similarity matrix 624 to determine a loss 630. In this case, the loss 630 may ensure that the distribution of the latent feature is aligned with the distribution of the original semantic feature of the text, thereby more accurately describing different types of priors. It would be appreciated that FIG. 6 only schematically shows the case where there are four types, and a dimensionality of the matrix is 4*4 in this case. Assuming that there are M types, the dimensionality of the matrix may be expressed as M*M.

According to some implementations of the present disclosure, a diffusion bridge may be combined with a standard diffusion model. Specifically, in the process of determining a diffusion model, an update parameter for updating a loss function of the diffusion model may be determined based on prior distributions of a plurality of prior texts in the latent space. The loss function of the diffusion model may be updated with the update parameter. Further, the diffusion model may be updated with the updated loss function. With some implementations of the present disclosure, a loss function of a diffusion model can be supported to compensate for the deviation caused by different types of prior distributions, so that the diffusion model may generate images that match the input text more in a more accurate manner.

Specifically, regarding the combination with the diffusion bridge, when working with the diffusion bridge, a method similar to a standard diffusion model may be utilized. The predefined noise schedule allows a conditional score ∇ₓ, log q(1(xₜ|x₀, μ_{T}) to be computed in closed form. The theorem shows that a neural network s_{θ}(xₜ, x_{T}, t) may be trained to approximate the true score by matching the true score with this closed-form expression.

Consider a sample (x₀, μ_{T}) drawn from a data distribution q_{data}(x, μ_{T}), an intermediate point xₜ sampled from a bridge distribution q(xₜ|x₀, x_{T}) and a time point t sampled from any non-zero distribution p(t) on [0, T]. Let w(t) be any non-zero weighting function. The following loss function may exist:

$${𝔼}_{{x}_{t} , {x}_{0} , {μ}_{T} , t} [ w ( t ) {‖ {s}_{θ} ( {x}_{t} , {μ}_{T} , t ) - {∇}_{{x}_{t}} log q ( {x}_{t} \vert {x}_{0} , {μ}_{T} ) ‖}^{2} ]$$

In the process of minimizing the above formula, it is ensured that s_{θ}(xₜ, μ_{T}, t)=∇ₓ_{ₜ} log q(xₜ|μ_{T}). The theorem shows how to construct a trainable diffusion bridge between two endpoints. By matching a output neural network with the conditional score of a Gaussian bridge, the score inside q(xₜ|μ_{T}) may be learned and modeled, and the distribution of which is consistent with the target marginal distribution q(xₜ|x₀, μ_{T}).

According to some implementations of the present disclosure, in the process of determining the update parameter for updating the loss function of the diffusion model, a type of a diffusion process used in the diffusion model may be determined, and then the update parameter may be determined, based on the prior distributions, according to the type of the diffusion process. With some implementations of the present disclosure, different types of diffusion models may be processed separately in a more accurate manner, thereby improving the performance of the diffusion model.

According to some implementations of the present disclosure, the VE, VP, and OU processes in the diffusion model are three different diffusion processes, which differ in the way of adding noise and generating data. In the VE process, the variance of the noise added at each step will gradually increase. This process will cause the variance of the data to expand rapidly, making the diffusion process convert the data into noise more quickly. Due to the rapid increase of the variance, the VE process may lead to unstable quality of the generated data in some tasks. In the VP process, the variance of the noise added at each step remains unchanged. This process makes the diffusion process of the data more stable by fixing the noise variance. The VP process performs better in generating high-quality data because it may better control the process of adding noise. The OU process is a stochastic process used to simulate the dynamic changes of data. It is used in the diffusion model to simulate the gradual change of data, rather than simply adding noise. The OU process performs well in processing time series data because it may capture the long-term dependence of the data.

For some popular diffusion models (including the VE, VP, and OU processes), the transition probability q(xₜ|x₀, μ_{T}) of the diffusion bridge may be provided.

$${\overline{α}}_{t} = {\prod }_{i = 1}^{t} {α}_{i}$$

may be set, and q(xₜ|x₀, μ_{T}) in the above loss function may be replaced with the following three diffusion bridges, respectively:

$$VE bridge : 𝒩 ( ( 1 - \frac{t}{T} ) {x}_{0} + \frac{t}{T} {μ}_{T} , \frac{t ( T - t )}{T} I )$$

$$VP bridge : 𝒩 ( \sqrt{{\overline{α}}_{t}} {x}_{0} + ( 1 - \sqrt{{\overline{α}}_{t}} ) {μ}_{T} , ( 1 - {\overline{α}}_{t} ) I )$$

$$OU bridge : 𝒩 ( {x}_{0} {e}^{- θ t} + {μ}_{T} ( 1 - {e}^{- θ t} ) , \frac{1}{2 θ} ( 1 - {e}^{- 2 θ t} ) )$$

Different diffusion bridges may be integrated into the loss function to perform optimization based on variable requirements. The proposed framework may unify text embeddings, VAE-based reconstruction, and OU-driven diffusion. By adjusting a flexible text VAE and a stable OU diffusion bridge, the proposed technical solution may consistently generate images closely aligned with their corresponding text inputs, thereby providing interpretability and robustness in text-to-image synthesis.

In the present disclosure, the proposed technical solution may integrate a text variational autoencoder with an OU diffusion bridge, thereby enabling efficient and semantically consistent text-conditioned image generation. By utilizing text embeddings as unique priors and ensuring their alignment with image representations, our method provides improved stability and quality in generated images. Future work may explore extending this method to more complex conditional generation tasks and further optimizing the alignment mechanism to enhance performance.

In summary, the proposed technical solution may achieve better technical effects. First, the text VAE may effectively separate and align text representations and visual representations in a shared latent space and solve the instability caused by a homogeneous prior distribution. Second, the proposed OU process may enhance the sampling stability and reduce the path overlap, thereby enabling more accurate score direction estimation and efficient denoising. Experiments show that by applying the proposed technical solution on synthetic datasets and real-world datasets, the proposed technical solution may achieve better technical effects than the prior art in terms of both of performance and efficiency.

### Example Process

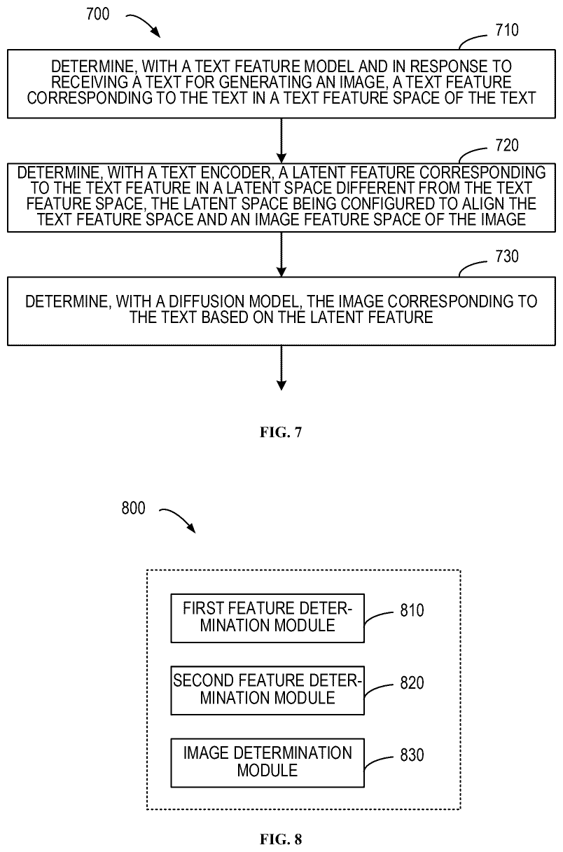

FIG. 7 illustrates a flowchart of a method 700 for generating an image based on a text in accordance with some implementations of the present disclosure. At a block 710, in response to receiving a text for generating an image, a text feature corresponding to the text is determined, with a text feature model, in a text feature space of the text. At a block 720, a latent feature corresponding to the text feature is determined, with a text encoder, in a latent space different from the text feature space, the latent space being configured to align the text feature space and an image feature space of the image. At a block 730, the image corresponding to the text is determined based on the latent feature with a diffusion model.

According to some implementations of the present disclosure, determining with the diffusion model the image corresponding to the text based on the latent feature includes: inputting the latent feature into the diffusion model as an initial noise feature; and performing, with the diffusion model, denoising processing for the initial noise feature to determine the image.

According to some implementations of the present disclosure, the text encoder is trained by: obtaining a reference sample, the reference sample including a reference text and a reference image; determining, via the latent space, a loss function for updating the text encoder based on the reference text and the reference image; and updating the text encoder based on the loss function.

According to some implementations of the present disclosure, determining via the latent space the loss function for updating the text encoder includes: determining, with the text encoder, a reference text feature corresponding to the reference text in the latent space; determining, with an image encoder, a reference image feature corresponding to the reference image in the latent space; and determining the loss function based on a difference between the reference text feature and the reference image feature.

According to some implementations of the present disclosure, determining via the latent space the loss function for updating the text encoder includes: determining, with the text encoder, a reference text feature corresponding to the reference text in the latent space; determining, with an image decoder, a reference reconstructed image corresponding to the reference text feature; and determining the loss function based on a difference between the reference reconstructed image and the reference image.

According to some implementations of the present disclosure, the reference sample includes a first reference sample and a second reference sample, a first type of a first reference text in the first reference sample is different from a second type of a second reference text in the second reference sample, and determining via the latent space the loss function for updating the text encoder includes: obtaining prior distributions of a plurality of texts respectively corresponding to the first type and the second type in the latent space; determining respectively, with the text encoder, a first reference text feature corresponding to the first reference text and a second reference text feature corresponding to the second reference text in the latent space; determining a distribution of the first reference text feature and the second reference text feature in the latent space; and determining the loss function based on a difference between the prior distributions and the distribution.

According to some implementations of the present disclosure, the diffusion model is determined by: determining an update parameter for updating a loss function of the diffusion model based on prior distributions of a plurality of prior texts in the latent space; updating, with the update parameter, the loss function of the diffusion model; and updating, with the updated loss function, the diffusion model.

According to some implementations of the present disclosure, determining the update parameter for updating the loss function of the diffusion model includes: determining a type of a diffusion process used in the diffusion model; and determining, based on the prior distributions, the update parameter according to the type of the diffusion process.

According to some implementations of the present disclosure, a dimensionality of the latent space is higher than a dimensionality of the text feature space, and the dimensionality of the latent space is determined based on a dimensionality of the image feature space of the image.

According to some implementations of the present disclosure, the text encoder includes an interpolation layer set, the interpolation layer being based on a difference between the dimensionality of the image feature space and a dimensionality of the latent space.

### Example Apparatus and Device

FIG. 8 illustrates a block diagram of an apparatus 800 for generating an image based on a text in accordance with some implementations of the present disclosure. The apparatus includes: a first feature determination module 810 configured to determine, with a text feature model and in response to receiving a text for generating an image, a text feature corresponding to the text in a text feature space of the text; a second feature determination module 820 configured to determine, with a text encoder, a latent feature corresponding to the text feature in a latent space different from the text feature space, the latent space being configured to align the text feature space and an image feature space of the image; and an image determination module 830 configured to determine, with a diffusion model, the image corresponding to the text based on the latent feature.

According to some implementations of the present disclosure, the image determination module 830 is further configured to: input the latent feature into the diffusion model as an initial noise feature; and perform, with the diffusion model, denoising processing for the initial noise feature to determine the image.

According to some implementations of the present disclosure, the text encoder is trained by: obtaining a reference sample, the reference sample including a reference text and a reference image; determining, via the latent space, a loss function for updating the text encoder based on the reference text and the reference image; and updating the text encoder based on the loss function.

According to some implementations of the present disclosure, determining, via the latent space, the loss function for updating the text encoder includes: determining, with the text encoder, a reference text feature corresponding to the reference text in the latent space; determining, with an image encoder, a reference image feature corresponding to the reference image in the latent space; and determining the loss function based on a difference between the reference text feature and the reference image feature.

According to some implementations of the present disclosure, determining via the latent space the loss function for updating the text encoder includes: determining, with the text encoder, a reference text feature corresponding to the reference text in the latent space; determining, with an image decoder, a reference reconstructed image corresponding to the reference text feature; and determining the loss function based on a difference between the reference reconstructed image and the reference image.

According to some implementations of the present disclosure, the reference sample includes a first reference sample and a second reference sample, a first type of a first reference text in the first reference sample is different from a second type of a second reference text in the second reference sample, and determining via the latent space the loss function for updating the text encoder includes: obtaining prior distributions of a plurality of prior texts respectively corresponding to the first type and the second type in the latent space; determining respectively, with the text encoder, a first reference text feature corresponding to the first reference text and a second reference text feature corresponding to the second reference text in the latent space; determining a distribution of the first reference text feature and the second reference text feature in the latent space; and determining the loss function based on a difference between the prior distributions and the distribution.

According to some implementations of the present disclosure, the diffusion model is determined by: determining an update parameter for updating a loss function of the diffusion model based on prior distributions of a plurality of prior texts in the latent space; updating, with the update parameter, the loss function of the diffusion model; and updating, with the updated loss function the diffusion model.

According to some implementations of the present disclosure, determining the update parameter for updating the loss function of the diffusion model includes: determining a type of a diffusion process used in the diffusion model; and determining, based on the prior distributions, the update parameter according to the type of the diffusion process.

According to some implementations of the present disclosure, a dimensionality of the latent space is higher than a dimensionality of the text feature space, and the dimensionality of the latent space is determined based on a dimensionality of the image feature space of the image.

According to some implementations of the present disclosure, the text encoder includes an interpolation layer, the interpolation layer being set based on a difference between the dimensionality of the image feature space and the dimensionality of the latent space.

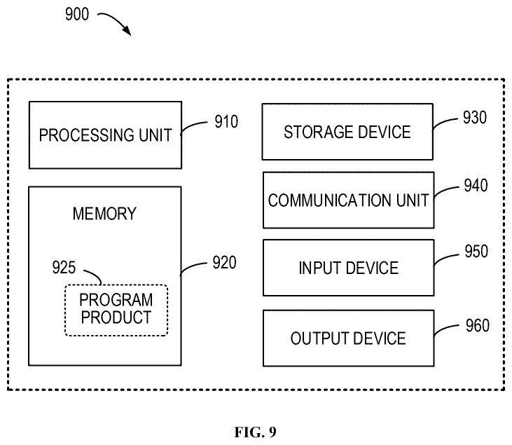

FIG. 9 illustrates a block diagram of a device capable of implementing a plurality of implementations of the present disclosure. It would be appreciated that the computing device 900 shown in FIG. 9 is merely illustrative and should not be construed as any limitation on the functionality and scope of the implementations described herein. The computing device 900 shown in FIG. 9 may be configured to implement the method described above.

As shown in FIG. 9, the computing device 900 is in the form of a general-purpose computing device. Components of the computing device 900 may include, but are not limited to, one or more processors 910, a memory 920, a storage device 930, one or more communication units 940, one or more input devices 950, and one or more output devices 960. The processor 910 may be an actual or virtual processor and may perform various processes based on the program stored in the memory 920. In a multi-processor system, multiple processors execute computer executable instructions in parallel to improve the parallel processing capability of the computing device 900.

The computing device 900 typically includes a plurality of computer storage medium. Such medium may be any available medium that is accessible to the computing device 900, including, but not limited to, volatile and non-volatile medium, removable and non-removable medium. The memory 920 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 930 may be any removable or non-removable medium, and may include a machine-readable medium such as a flash drive, a disk, or any other medium, which may be configured to store information and/or data (such as training data for training) and may be accessed within the computing device 900.

The computing device 900 may further include additional removable/non-removable, volatile/non-volatile memory medium. Although not shown in FIG. 9, a disk driver for reading from or writing to a removable, non-volatile disk (such as a “floppy disk”), and an optical disk driver for reading from or writing to a removable, non-volatile optical disk may be provided. In these cases, each driver may be connected to a bus (not shown) by one or more data medium interfaces. The memory 920 may include a computer program product 925 having one or more program modules configured to perform various methods or acts of various implementations of the present disclosure.

The communication unit 940 enables communication with other computing devices through the communication medium. Additionally, the functions of the components of the computing device 900 may be implemented by a single computing cluster or multiple computing machines, which may communicate through communication connections. Therefore, the computing device 900 may use a logical connection with one or more other servers, a network personal computer (PC), or another network node to operate in a networked environment.

The input device 950 may be one or more input devices, such as a mouse, a keyboard, a tracking ball, etc. The output device 960 may be one or more output devices, such as a display, a speaker, a printer, etc. The computing device 900 may also communicate with one or more external devices (not shown) such as a storage device, a display device, etc. as needed through the communication unit 940, communicate with one or more devices that enable the user to interact with the computing device 900, or communicate with any device (e.g., a network card, a modem, etc.) that enables the computing device 900 to communicate with one or more other computing devices. Such communication may be performed via input/output (I/O) interfaces (not shown).

According to an implementation of the present disclosure, there is provided a computer-readable storage medium having stored thereon computer-executable instructions, where the computer-executable instructions are executed by a processor to implement the method described above. According to an implementation of the present disclosure, there is further provided a computer program product tangibly stored on a non-transitory computer-readable medium and including computer-executable instructions, while the computer-executable instructions are executed by a processor to implement the method described above. According to an implementation of the present disclosure, there is provided a computer program product having stored thereon a computer program that, when executed by a processor, implements the method described above.

Various aspects of the present disclosure are described herein with reference to flowcharts and/or block diagrams of the method, the apparatus, the device, and the computer program product implemented in accordance with the present disclosure. It would be appreciated that each block of the flowchart and/or block diagrams, and combinations of blocks in the flowchart and/or block diagrams, may be implemented by computer-readable program instructions.

These computer-readable program instructions may be provided to a processor of a general-purpose computer, a special-purpose computer, or other programmable data processing apparatus to produce a machine, such that when the instructions are executed by the processor of the computer or other programmable data processing apparatus, an apparatus for implementing the functions/acts specified in one or more blocks of the flowchart and/or block diagrams is produced. These computer-readable program instructions may also be stored in a computer-readable storage medium. The instructions cause the computer, the programmable data processing apparatus, and/or other devices to work in a particular manner, so that the computer-readable medium storing the instructions includes an article of manufacture including instructions for implementing various aspects of the functions/acts specified in one or more blocks of the flowchart and/or block diagrams.

The computer-readable program instructions may be loaded onto a computer, other programmable data processing apparatus, or other device, causing a series of operating steps to be performed on the computer, other programmable data processing apparatus, or other device to produce a computer-implemented process, such that the instructions executed on the computer, other programmable data processing apparatus, or other device implement the functions/acts specified in one or more blocks of the flowchart and/or block diagrams.

The flowchart and block diagrams in the drawings show the possibly implemented architectures, functions, and operations of the system, method, and computer program product according to a plurality of implementations of the present disclosure. In this regard, each block in the flowchart or block diagrams may represent a module, program segment, or portion of instructions. The module, program segment, or portion of instructions include one or more executable instructions for implementing the specified logical functions. In some alternative implementations, the functions indicated in the blocks may occur in an order different from that indicated in the drawings. For example, two consecutive blocks may actually be performed substantially in parallel, or they may sometimes be performed in the reverse order, depending upon the functionality involved. It would also be noted that each block of the block diagrams and/or flowchart, and combinations of the blocks in the block diagrams and/or flowchart, may be implemented by special purpose hardware-based systems that perform the specified functions or acts, or combinations of special purpose hardware and computer instructions.

The implementations of the present disclosure have been described above, and the above description is illustrative, non-exhaustive, and not limited to the disclosed implementations. Many modifications and variations will be apparent to those of ordinary skill in the art without departing from the scope of the described implementations. The choice of terms used herein is intended to best explain the principles of the implementations, the practical application, or improvements to the technology in the market, or to enable other ordinary skilled persons in the art to understand the implementations disclosed herein.

1. A method of generating an image based on a text, comprising:
determining, with a text feature model and in response to receiving a text for generating an image, a text feature corresponding to the text in a text feature space of the text;
determining, with a text encoder, a latent feature corresponding to the text feature in a latent space different from the text feature space, the latent space being configured to align the text feature space and an image feature space of the image; and
determining, with a diffusion model, the image corresponding to the text based on the latent feature.

2. The method of claim 1, wherein determining with the diffusion model the image corresponding to the text based on the latent feature comprises:
inputting the latent feature into the diffusion model as an initial noise feature; and
performing, with the diffusion model, denoising processing for the initial noise feature to determine the image.

3. The method of claim 1, wherein the text encoder is trained by:
obtaining a reference sample, the reference sample comprising a reference text and a reference image;
determining, via the latent space, a loss function for updating the text encoder based on the reference text and the reference image; and
updating the text encoder based on the loss function.

4. The method of claim 3, wherein determining via the latent space the loss function for updating the text encoder comprises:
determining, with the text encoder, a reference text feature corresponding to the reference text in the latent space;
determining, with an image encoder, a reference image feature corresponding to the reference image in the latent space; and
determining the loss function based on a difference between the reference text feature and the reference image feature.

5. The method of claim 3, wherein determining via the latent space the loss function for updating the text encoder comprises:
determining, with the text encoder, a reference text feature corresponding to the reference text in the latent space;
determining, with an image decoder, a reference reconstructed image corresponding to the reference text feature; and
determining the loss function based on a difference between the reference reconstructed image and the reference image.

6. The method of claim 3, wherein the reference sample comprises a first reference sample and a second reference sample, a first type of a first reference text in the first reference sample is different from a second type of a second reference text in the second reference sample, and determining via the latent space the loss function for updating the text encoder comprises:
obtaining prior distributions of a plurality of prior texts respectively corresponding to the first type and the second type in the latent space;
determining respectively, with the text encoder, a first reference text feature corresponding to the first reference text and a second reference text feature corresponding to the second reference text in the latent space;
determining a distribution of the first reference text feature and the second reference text feature in the latent space; and
determining the loss function based on a difference between the prior distributions and the distribution.

7. The method of claim 1, wherein the diffusion model is determined by:
determining an update parameter for updating a loss function of the diffusion model based on prior distributions of a plurality of prior texts in the latent space;
updating, with the update parameter, the loss function of the diffusion model; and
updating, with the updated loss function, the diffusion model.

8. The method of claim 7, wherein determining the update parameter for updating the loss function of the diffusion model comprises:
determining a type of a diffusion process used in the diffusion model; and
determining, based on the prior distributions, the update parameter according to the type of the diffusion process.

9. The method of claim 1, wherein a dimensionality of the latent space is higher than a dimensionality of the text feature space, and the dimensionality of the latent space is determined based on a dimensionality of the image feature space of the image.

10. The method of claim 1, wherein the text encoder comprises an interpolation layer, the interpolation layer being set based on a difference between a dimensionality of the image feature space and a dimensionality of the latent space.

11. An electronic device, comprising:
at least one processor; and
at least one memory, the at least one memory being coupled to the at least one processor and storing instructions for execution by the at least one processor, the instructions, when executed by the at least one processor, causing the electronic device to perform acts comprising:
determining, with a text feature model and in response to receiving a text for generating an image, a text feature corresponding to the text in a text feature space of the text;
determining, with a text encoder, a latent feature corresponding to the text feature in a latent space different from the text feature space, the latent space being configured to align the text feature space and an image feature space of the image; and
determining, with a diffusion model, the image corresponding to the text based on the latent feature.

12. The electronic device of claim 11, wherein determining with the diffusion model the image corresponding to the text based on the latent feature comprises:
inputting the latent feature into the diffusion model as an initial noise feature; and
performing, with the diffusion model, denoising processing for the initial noise feature to determine the image.

13. The electronic device of claim 11, wherein the text encoder is trained by:
obtaining a reference sample, the reference sample comprising a reference text and a reference image;
determining, via the latent space, a loss function for updating the text encoder based on the reference text and the reference image; and
updating the text encoder based on the loss function.

14. The electronic device of claim 13, wherein determining via the latent space the loss function for updating the text encoder comprises:
determining, with the text encoder, a reference text feature corresponding to the reference text in the latent space;
determining, with an image encoder, a reference image feature corresponding to the reference image in the latent space; and
determining the loss function based on a difference between the reference text feature and the reference image feature.

15. The electronic device of claim 13, wherein determining via the latent space the loss function for updating the text encoder comprises:
determining, with the text encoder, a reference text feature corresponding to the reference text in the latent space;
determining, with an image decoder, a reference reconstructed image corresponding to the reference text feature; and
determining the loss function based on a difference between the reference reconstructed image and the reference image.

16. The electronic device of claim 13, wherein the reference sample comprises a first reference sample and a second reference sample, a first type of a first reference text in the first reference sample is different from a second type of a second reference text in the second reference sample, and determining via the latent space the loss function for updating the text encoder comprises:
obtaining prior distributions of a plurality of prior texts respectively corresponding to the first type and the second type in the latent space;
determining respectively, with the text encoder, a first reference text feature corresponding to the first reference text and a second reference text feature corresponding to the second reference text in the latent space;
determining a distribution of the first reference text feature and the second reference text feature in the latent space; and
determining the loss function based on a difference between the prior distributions and the distribution.

17. The electronic device of claim 11, wherein the diffusion model is determined by:
determining an update parameter for updating a loss function of the diffusion model based on prior distributions of a plurality of prior texts in the latent space;
updating, with the update parameter, the loss function of the diffusion model; and
updating, with the updated loss function, the diffusion model.

18. The electronic device of claim 17, wherein determining the update parameter for updating the loss function of the diffusion model comprises:
determining a type of a diffusion process used in the diffusion model; and
determining, based on the prior distributions, the update parameter according to the type of the diffusion process.

19. The electronic device of claim 11, wherein a dimensionality of the latent space is higher than a dimensionality of the text feature space, and the dimensionality of the latent space is determined based on a dimensionality of the image feature space of the image.

20. A non-transitory computer-readable storage medium having stored thereon computer instructions that, when executed by a processor, cause the processor to implement acts comprising:
determining, with a text feature model and in response to receiving a text for generating an image, a text feature corresponding to the text in a text feature space of the text;
determining, with a text encoder, a latent feature corresponding to the text feature in a latent space different from the text feature space, the latent space being configured to align the text feature space and an image feature space of the image; and
determining, with a diffusion model, the image corresponding to the text based on the latent feature.
